(19) United States
(12) Patent Application Publication
(10) Pub. No.: US 2019/0277319 A1
(43) Pub. Date: Sep. 12, 2019

(54) ASSEMBLY AND METHOD FOR ATTACHING TWO COMPONENTS

(71) Applicant: Ford Global Technologies, LLC, Dearborn, MI (US)

(72) Inventor: Christopher Ponter, Romford (GB)

(21) Appl. No.: 16/293,489

(22) Filed: Mar. 5, 2019

(30) Foreign Application Priority Data
Mar. 8, 2018 (GB) 1803716.8

(51) Int. Cl. F16B 5/02; F16B 31/02

(52) U.S. Cl. CPC F16B 5/02; F16B 31/02

(57) ABSTRACT

Methods and systems are provided for a coupling system. In one example, the coupling system is shaped to receive a fastener through complementary first and second bores. The first bore comprising a tapered alignment feature and the second bore comprising a tapered receiving portion to receive the alignment feature.

### CROSS REFERENCE TO RELATED APPLICATION

The present application claims priority to Great Britain Patent Application No. 1803716.8, filed Mar. 8, 2018. The entire contents of the above-referenced application are hereby incorporated by reference for all purposes.

### FIELD

The present description relates generally to an assembly and method for attaching two components and particularly, although not exclusively, relates to an assembly and method for attaching and aligning two components within a motor vehicle.

### BACKGROUND/SUMMARY

When one component is joined to another, it is desirable that they are correctly aligned with respect to one another as they are brought into engagement. Traditionally this is done using alignment pins provided in one of the components and corresponding recesses in the other component. However, adding such alignment pins and recesses adds additional features to the components, which need fabrication, take up space, and add cost.

Other examples of addressing joining two components together include introducing a compression limiter to a mount. One example approach is shown by Lou et al. in U.S. 2017/0284563. Therein, a coolant valve mounting comprises a housing with a through aperture, a mounting base, and a compression limiter with a throughhole axially aligned with the through aperture. The compression limiter comprises a first portion with an outer surface disposed within the through aperture and a second portion forming a shelf on the compression limiter that supports the housing.

However, the inventors have identified some issues with the example described above. For example, the mounting base is not shaped to receive a fastener entirely therethrough. In some applications, such as automotive applications, the mounting of Lou may be loosened due to vibrational forces as a result of combustion, driving, and other vehicle operations. Furthermore, the aperture of the mounting base into which the compression limiter is inserted comprises a cylindrical shape similar to the shape of the compression limiter. However, surface tension between the compression limiter and the aperture of the mounting base may increase as the compression limiter is inserted therein, resulting in an increased difficulty of manufacture. Additionally, the increase surface tension may result in increased wear of the surfaces of the compression limiter and/or the aperture of the mounting base.

In one example, the issues described above may be addressed by a system comprising a first component comprising a first component bore with a first diameter and a second component comprising a second component bore, the first component bore traversing an entire length of the first component and the second component bore traversing an entire length of the second component, the second component bore comprising a first taper at its entry, and a compression limiter comprising a total diameter complementary to the first diameter, the compression limiter extending through an entire length of the first component bore, further comprising an alignment feature protruding outside of the first component bore, the alignment feature comprising a second taper shaped to match the first taper. In this way, surface tension experienced by an assembly worker as the compression limiter is inserted into the second component bore may be decreased, resulting in reduced assembly times.

As one example, tapering the compression limiter allows insertion of the compression limiter into the second component bore to be easier than the taper being omitted. When the taper is omitted, the diameters of the bore into which the compression limiter will be inserted and the compression limiter are complementary throughout their lengths. As such, an axial alignment may be desired before the compression limiter without a taper may be inserted into the receiving bore. However, by tapering both the compression limiter and the receiving bore, a mismatch of diameters may be present at a compression limiter extreme end and an extreme end (e.g., an inlet) of the receiving bore. In this way, the compression limiter may be inserted axially or at an angle relative to the axial direction into the receiving bore. By doing this, assembly of a device via the system may be faster, resulting in decreased manufacturing costs.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIGS. 1A, 1B, and 1C are side sectional views of an assembly according to an example of the present disclosure in which FIG. 1A shows first and second components prior to engagement, FIG. 1B shows the first and second components when mated, and FIG. 1C shows the first and second components fastened together;

FIG. 2 illustrates a side sectional view of an assembly according to a further example of the present disclosure;

FIG. 3 illustrates a side sectional view of an assembly according to another example of the present disclosure

FIG. 4 illustrates a flow chart depicting a method according to an example of the present disclosure.

### DETAILED DESCRIPTION

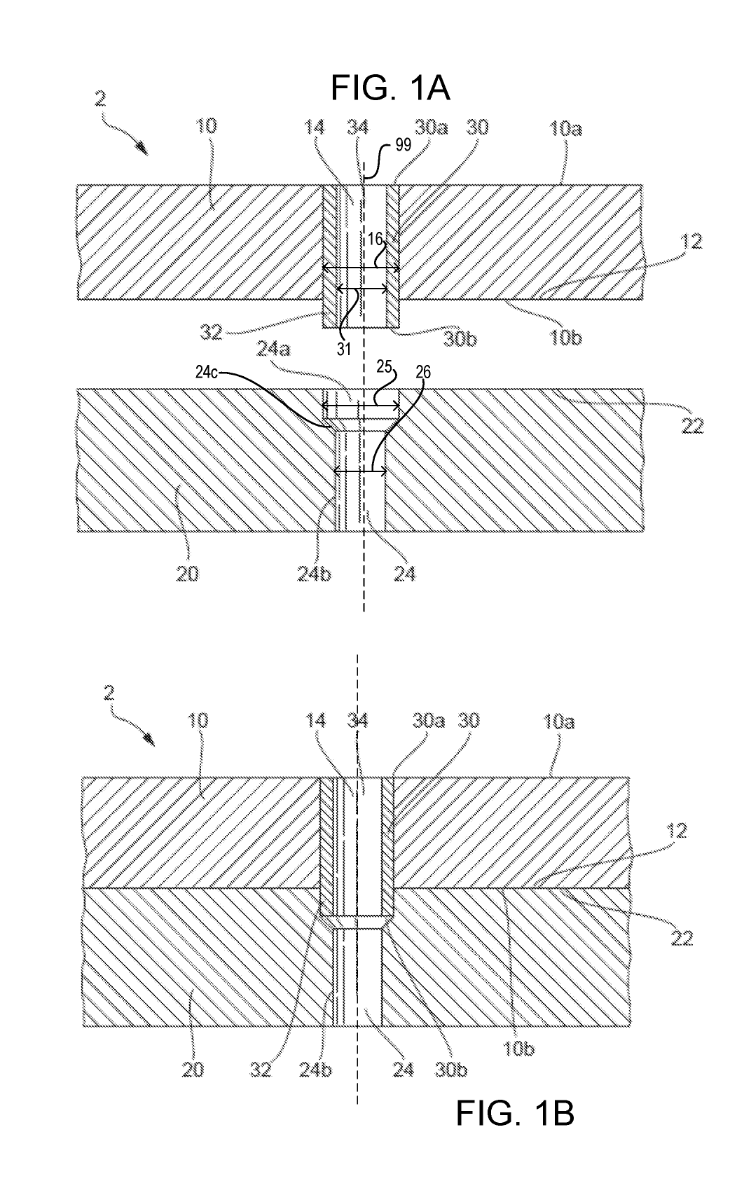

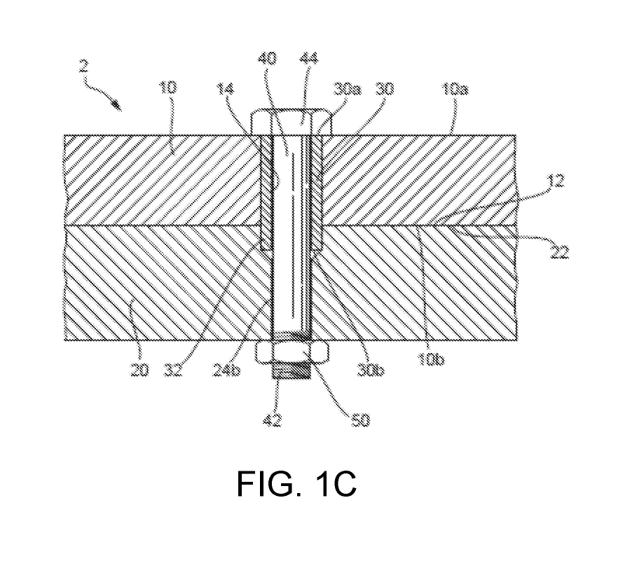

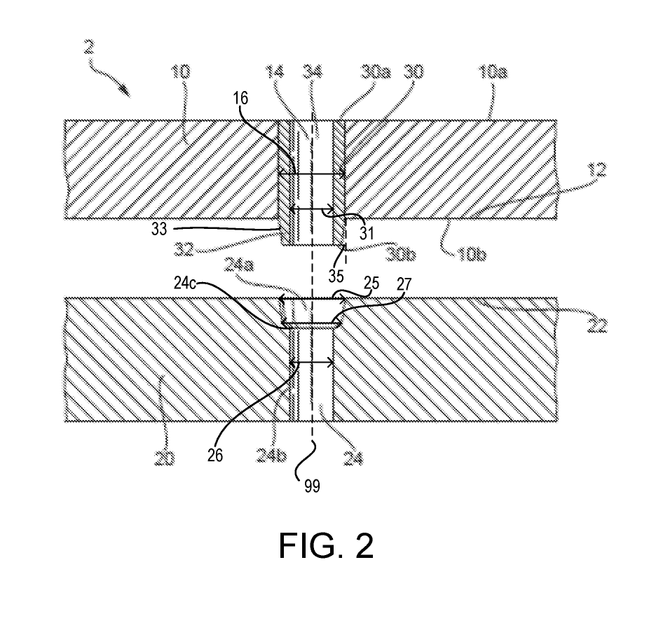

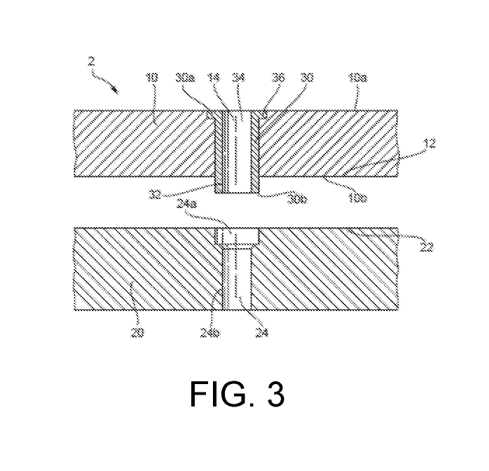

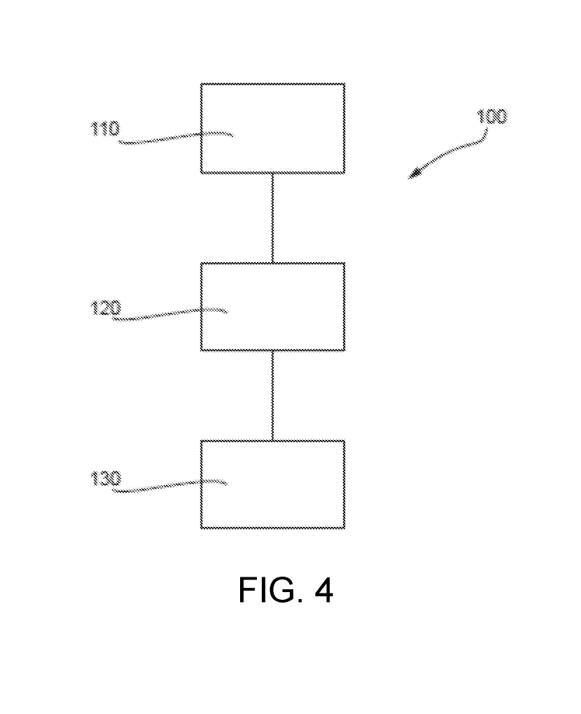

The following description relates to systems and methods for a compression limiter and a receiving bore for coupling a first device to a second device. FIGS. 1A-1C are side sectional views of an assembly according to an example of the present disclosure in which FIG. 1A shows first and second components prior to engagement, FIG. 1B shows the first and second components when mated, and FIG. 1C shows the first and second components fastened together. FIG. 2 illustrates a side sectional view of an assembly according to a further example of the present disclosure. FIG. 3 illustrates a side sectional view of an assembly according to another example of the present disclosure. FIG. 4 illustrates a flow chart depicting a method according to an example of the present disclosure.

According to an aspect of the present disclosure, there is provided an assembly comprising a first component attachable to a second component with a fastener, the first component having a bore, the second component comprising a bore for receiving the fastener, and a compression limiter configured to fit inside and extend through the bore of the first component, the compression limiter having a bore for receiving the fastener, wherein on a first side of the first component, the compression limiter presents a compression surface to the fastener and receives a compressive force via said compression surface, and wherein on a second side of the first component opposite the first side of the first component, the first component has a first mating surface that is configured to face a second mating surface of the second component, wherein the compression limiter extends between the first and second sides of the first component and beyond the first mating surface so as to form an alignment feature that protrudes from the first mating surface and aligns the first component with the second component during attachment of the first and second components, wherein the second component bore has a first bore portion at, e.g. adjacent to, the second mating surface of the second component bore and a second bore portion away, e.g. spaced away from, from the second mating surface of the second component bore, the first bore portion having a diameter, e.g. average or minimum diameter, that is greater than the diameter of the second bore portion, and wherein the first bore portion has a variable diameter that varies with depth of the second bore portion.

The compression limiter may comprise a flange at the first side of the first component. An end face of the flange may form the compression surface.

The compression limiter may be flush with the first side of the first component. Alternatively, an end face of the compression limiter may be proud of the first side of the first component.

The first component bore and compression limiter bore may be aligned with each other. The first component bore and compression limiter bore may be concentric.

The compression limiter may be fabricated from a material with a higher yield strength, e.g. compressive yield strength, than the material from which the first component is fabricated.

The alignment feature of the compression limiter may have a substantially constant diameter along its length. Alternatively, the alignment feature of the compression limiter may have a diameter that tapers along its length, e.g. with smaller diameter at its distal end.

The first bore portion may form a counterbore. The first bore portion may be tapered, e.g. so that the second component bore is countersunk.

The shape and/or dimensions of the alignment feature of the compression limiter may correspond to the shape and/or dimensions of the first bore portion.

The fastener may be elongate. The fastener may comprise a threaded section. For example, the fastener may comprise a screw, bolt, stud or any other threaded fastener.

According to another aspect of the present disclosure, there is provided a method of attaching a first component and a second component together with a fastener, the first component having a first mating surface that is configured to face a second mating surface of the second component, wherein the method comprises providing a compression limiter inside and extending through a bore of the first component, wherein the compression limiter presents a compression surface to the fastener on a first side of the first component, and the first mating surface is on a second side of the first component opposite the first side of the first component, wherein the compression limiter extends between first and second sides of the first component and beyond the first mating surface so as to form an alignment feature that protrudes from the first mating surface, wherein the second component comprises a bore for receiving the fastener and the second component bore has a first bore portion at the second mating surface of the second component bore and a second bore portion away from the second mating surface of the second component bore, the first bore portion having a diameter that is greater than the diameter of the second bore portion, and wherein the first bore portion has a variable diameter that varies with depth of the second bore portion, aligning the first component with the second component during attachment of the first and second components, and fastening the first and second components together with a fastener inserted through a bore of the compression limiter.

To avoid unnecessary duplication of effort and repetition of text in the specification, certain features are described in relation to only one or several aspects or embodiments of the invention. However, it is to be understood that, where it is technically possible, features described in relation to any aspect or embodiment of the invention may also be used with any other aspect or embodiment of the disclosure.

FIGS. 1A-3 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within 1-5% deviation).

Turning now to FIG. 1, the present disclosure relates to an assembly 2 comprising a first component 10, shaped to couple to a second component 20. The first and second components 10, 20 may be components for a motor vehicle, such as an internal combustion engine of the motor vehicle. The first component 10 has a first mating surface 12 that is configured to face and mate with a second mating surface 22 of the second component 20. In some examples, the first component 10 may physically couple to the second component 20 with the first mating surface 12 in face-sharing contact with the second mating surface 22 with no intervening components arranged therebetween. Additionally or alternatively, a gasket may be arranged between the first mating surface 12 and the second mating surface 22 when the first component 10 is physically coupled to the second component 20.

The assembly 2 further comprises a compression limiter 30, which is provided in a bore 14 of the first component. The external dimensions of the compression limiter 30 substantially correspond to the internal dimensions of the first component bore 14. Accordingly, the compression limiter 30 fits inside the first component bore 14, e.g. with an interference fit. In a particular example, the compression limiter 30 and first component bore 14 have circular cross-sections, however, other cross-sectional shapes are possible. For example, the external shape of the compression limiter 30 may be non-circular and the internal shape of the first component bore 14 may have a corresponding non-circular shape. Such non-circular shapes, such as a triangle or square shape, may block relative rotation of the first component 10 and compression limiter 30.

The compression limiter 30 extends through the first component bore 14 and extends from a first side 10a of the first component to a second side 10b of the first component 10. The first mating surface 12 is provided on the second side 10b of the first component. A first end 30a of the compression limiter 30 may be substantially flush with the surrounding surface at the first side 10a of the first component. By contrast, a second end 30b of the compression limiter 30 extends beyond the first mating surface 12 on the second side 10b of the first component. Accordingly, the second end 30b of the compression limiter 30 protrudes from the second side 10b of the first component 10. The protrusion of the second end 30b may be shaped as an alignment feature 32 that aligns the first component 10 with the second component 20 during assembly of the first and second components.

The second component 20 comprises a bore 24. The second component bore 24, which may be referred to interchangeably as a receiving bore 24, may have a first bore portion 24a and a second bore portion 24b. The first bore portion 24a may be adjacent to the second mating surface 22 of the second component. The second bore portion 24b may be set back and/or spaced away from the second mating surface 22, for example with the first bore portion 24a between the second bore portion 24b and the second mating surface 22. The first bore portion 24a has a diameter, e.g. an average or minimum diameter, that is greater than the diameter of the second bore portion 24b.

Said another way, the second component 20 comprises the bore 24 which may comprise a variable diameter, wherein a diameter of the bore 24 is larger at the first bore portion 24a than the second bore portion 24b. The first bore portion 24a may comprise a first extreme end flush with the second mating surface 22 and a second extreme end interfacing with the second bore portion 24b. As illustrated, a diameter of the first extreme end may be larger than a diameter of the second extreme end of the first bore portion. In one example, the first bore portion 24a maintains the diameter of the first extreme end for some distance before gradually narrowing to the diameter of the second extreme end. In one example, the diameter of the second extreme end is substantially equal to a diameter of the second bore portion. In this way, the first bore portion 24a may comprise a variable diameter, wherein the variable diameter is equal to diameters greater than or equal to the diameter of the second bore portion 24b.

That is to say, FIG. 1A illustrates the first portion 10 and the second portion 20 comprising the first mating surface 12 and the second mating surface 22, respectively, shaped to be pressed against another when the first and second portions are joined (e.g., physically coupled). The first portion and the second portion 10,20 may represent a variety of components. In one example, the first portion 10 is an engine head and the second portion 20 is an engine block. In another example, the first portion 10 may be an auxiliary component and the second portion 20 may be a mount shaped to couple to the auxiliary component and a frame of a device, such as a vehicle. As another example, the first portion 10 may be an engine mount and the second portion 20 may be an engine. Additionally or alternatively, the first portion 10 may be a turbocharger and the second portion 20 may be a turbocharger mount. It will be appreciated that the assembly 2 may be arranged on a variety of devices outside of automotive applications, such as furniture and other devices assembled on an assembly line. The assembly 2 is shaped to accelerate an accuracy and alignment of the first portion 10 and the second portion 20 to decrease manufacturing costs.

The first portion 10 comprises the first component bore 14 having a first diameter 16. The first diameter 16 may be a fixed diameter, wherein the first diameter does not change along a central axis 99 of the first component bore 14. The compression limiter 30 extends through an entire length of the first component bore 14 and protrudes from the first mating surface 12 toward the second mating surface 22.

The compression limiter 30 comprises a second diameter 31, which is less than the first diameter 16. In one example, the difference between the second diameter 31 and the first diameter 16 is equal to a thickness of the compression limiter 30.

The second portion 20 comprises the second component bore 24 having the first bore portion 24a and the second bore portion 24b. The first bore portion 24a and the second bore portion 24b are continuous with one another. The first bore portion 24a may be arranged adjacent to the second mating surface 22. The first bore portion 24a may comprise a third diameter 25 equal to the first diameter 16. As such, the compression limiter 30 may be inserted into the first bore portion 24a. In one example, the portion of the compression limiter 30 pressed into the first bore portion 24a is the alignment feature 32.

Between the first bore portion 24a and the second bore portion 24b there is arranged a taper 24c. The taper 24c may decrease in diameter, where a greatest diameter of the taper 24c is equal to the third diameter 25 and where a smallest diameter of the taper 24c is equal to a fourth diameter 26 of the second bore portion 24b. As such, the third diameter 25 is larger than the fourth diameter 26, wherein the taper gradually decreases in diameter from the third diameter 25 to the fourth diameter 26. By doing this, the taper 24c may block the compression limiter 30 from entering the second portion 24b. In this way, degradation to the first portion 10 and/or the second portion 20 as a result of over application of force during an assembly process, which may result in warping, cracking, bending, and the like may be avoided.

As depicted in FIGS. 1B and 1C, the alignment feature 32 of the compression limiter 30 may fit within the first bore portion 24a of the second component bore 24. The first bore portion 24a and alignment feature 32 may together cooperate to help align the first and second components 10, 20 during assembly. Accordingly, the shape and/or dimensions of the alignment feature 32 may correspond to the shape and/or dimensions of the first bore portion 24a.

The compression limiter 30 comprises a bore 34 that extends through the length of the compression limiter. The first component bore 14 and the compression limiter bore 34 may be aligned with each other so that they are co-axial. The compression limiter bore 34 may be circular in cross-section and in the event that the first component bore 14 is also circular, the first component bore 14 and compression limiter bore 34 may be concentric about the central axis 99.

The compression limiter bore 34 may receive a fastener 40, as depicted in FIG. 1C. The fastener 40 is substantially elongate and passes through the compression limiter bore 34 and second component bore 24 so as to fasten the first and second components 10, 20 together. The fastener 40 may comprise a threaded section 42, which may engage a corresponding thread in the second component bore 24 or, as depicted, a nut 50 may engage the threaded section 42 of the fastener 40. The fastener 40 may comprise a head 44 at an opposite end to the threaded section 42. Accordingly, the fastener 40 may be a bolt. However, it is also envisaged that the fastener may comprise a screw, stud or any other type of fastener that is able to hold the first and second components 10, 20 together.

The fastener 40 applies a compressive force and/or a tightening force to the first and second components 10, 20. The compression limiter 30 presents a compression surface at its first end 30a to the fastener 40, e.g. the fastener head 44. The compression surface of the compression limiter 30 receives a compressive force from the fastener 40. The compression limiter 30 may be made from a material with a higher compressive yield strength than the material of the first component 10. For example, the compression limiter 30 may be made from a metal, ceramic, a composite material, or a combination thereof. The first component 10 may be made from a material with a lower compressive yield strength, such as a plastic material, which may decrease a manufacturing cost of the first component 10. The compression limiter 30 may therefore block the first component 10 from receiving excessive compression forces applied by the fastener 40. In order to receive a compressive force, the compression limiter first end 30a may be flush with the first side 10a of the first component 10. Alternatively, the first end 30a of the compression limiter may be proud of the first side 10a of the first component.

As shown in FIG. 1, the alignment feature 32 of the compression limiter 30 may have a substantially constant diameter along its length. Likewise, the first bore portion 24a of the second component bore 24 may also have a constant diameter across its depth. The first bore portion 24a may thus form a counterbore. However, with reference to FIG. 2, the alignment feature 32 of the compression limiter 30 may have a diameter that varies along its length. For example, the diameter of the alignment feature may taper along its length, in particular so that the diameter reduces towards the second end 30b of the compression limiter 30. The first bore portion 24a of the second component may have a diameter that varies in a manner corresponding to that of the alignment feature 32. For example, the first bore portion 24a may be tapered, e.g. so that the second component bore 24 is countersunk.

Said another way, the example of FIG. 2 shows the alignment feature 32 of the compression limiter comprising a taper 33. The taper 33 may decrease an outer diameter of the compression limiter 30, without decreasing the second diameter 31 of the compression limiter bore 34. More specifically, the taper 33 is arranged on only the alignment feature 32, such that outer surfaces of the compression limiter 30 are in face-sharing contact with interior surfaces of the first component bore 14. However, outside of the first component bore 14 where the alignment feature 32 is arranged, the taper 33 is also arranged and decreases a thickness of the compression limiter 30 so that a total diameter of the compression limiter 30 is closed to the second diameter 31. It will be appreciated that the total diameter may be complementary to the first diameter 16 such that the compression limiter 30 may be pressed through the first component bore 14 with respective surfaces of the compression limiter 30 and the first component bore 14 being in contact with one another. However, the taper 33 may adjust the total diameter so that if the alignment feature 32 were to be arranged in the first component bore 14, a gap would be arranged between the alignment feature 32 and the interior surfaces of the first component bore 14 due to the taper 33.

In one example, the taper 33 may be honed, cut, ground, or the like into the outer surface of the compression limiter 30. The taper 33 may be arranged at an angle 35, which may be an acute angle. In one example, the angle 35 is less than 50 degrees. In some examples, additionally or alternatively, the angle 35 is less than 40 degrees. In some examples, additionally or alternatively, the angle 35 is less than 30 degrees. In some examples, additionally or alternatively, the angle 35 is less than 20 degrees. In some examples, additionally or alternatively, the angle 35 is less than 15 degrees. In some examples, additionally or alternatively, the angle 35 is less than 15 degrees. In some examples, additionally or alternatively, the angle 35 is less than 10 degrees.

In some examples, additionally or alternatively, the angle 35 is less than 5 degrees. In one example, the angle 35 is between 7 to 13 degrees. In one example, the angle 35 is equal to exactly 10 degrees. By shaping the taper 33 at an acute angle, a thickness of the compression limiter 30 is decreased to a lesser extent than a larger angle. As such, the durable material of the compression material 30 may still mitigate a force of a fastener onto a material of the first portion 10, which may be less durable than the compression material 30 to decrease manufacturing costs.

In the example of FIG. 2, the first bore portion 24a comprises a variable diameter, which decreases from the third diameter 25 to a fifth diameter 27 at a beginning of the taper 24c. The first bore portion 24a may be shaped to receive the alignment feature 32 and the taper 33. In this way, the first bore portion 24a may be tapered in a complementary manner to the taper 33 so that surfaces of the alignment feature 32 are pressed against surfaces of the first bore portion 24a.

Herein, taper 24c is interchangeably referred to as a first taper 24c and taper 33 is interchangeably referred to as a second taper 33. As such, the first taper 24c gradually decreases from the fifth diameter 27 to the fourth diameter 26 of the second bore portion 24b. In one example, a difference between the third diameter and the fifth diameter 27 may be less than a difference between the fifth diameter 27 and the fourth diameter 26. That is to say, a rate at which the first taper 24c decreases from the fifth diameter 27 to the fourth diameter 26 is greater than a rate at which the first bore portion 24a decreases from the third diameter 25 to the fifth diameter 27. As such, an angle of the first taper 24c may be greater than the angle 35. In one example, the angle of the first taper 24c is greater than 30 degrees. In another example, the angle of the first taper 24c is greater than 40 degrees. In another example, additionally or alternatively, the angle of the first taper 24c is greater than 50 degrees. In one example, the angle of the first taper 24c is between 35 to 55 degrees.

By gradually decreasing the diameter of the alignment feature 32 and the first bore portion 24a, the alignment feature 32 may be more easily pressed into the first bore portion 24a. As such, a time of manufacturing may decrease, which may result in reduced manufacturing costs. The alignment feature 32 with the taper 33 may be pressed into the first bore portion 24a with the decreasing diameter more easily than the example shown in FIGS. 1A, 1B, and 1C due to decreased frictional resistance applied by surfaces of the alignment feature 32 and the first bore portion 24a.

Additionally, the tapered alignment feature 32 may be inserted more easily into the tapered first bore portion 24a due to a mismatch of diameters. That is to say, a diameter at the extreme end of the taper 33 of the alignment feature, which may be equal to the fifth diameter 27, is less than a diameter at an extreme end corresponding to an entry of the first bore portion 24a, which may be equal to the third diameter 25. As described above, the third diameter 25 may be greater than the fifth diameter 27, which may provide the alignment feature 32 some amount of clearance and/or a gap between it and surfaces of the first bore portion 24a. As such, unlike the examples of FIGS. 1A, 1B, and 1C where the alignment feature 32 is axially aligned with the first bore portion 24a along the central axis 99 to allow the compression limiter 30 to be inserted into the second component 20, the alignment feature 32 may be inserted at a small angle relative to the central axis 99 while still allowing the compression limiter 30 to enter the second component 20.

In some examples, where a gasket or other sealing material is to be arranged between the first mating surface 12 and the second mating surface 22, the second taper 33 may begin outside of a region of the gasket. That is to say, the second taper 33 may comprise a length equal to a length of the first bore portion 24a. In this way, the portion of the alignment feature 32 in contact with the gasket may not be tapered.

As depicted in FIGS. 1A, 1B, and 1C, the compression limiter 30 may have a substantially constant diameter between the first and second sides 10a, 10b of the first component. However, with reference to FIG. 3, the compression limiter 30 may comprise a flange 36 at its first end 30a. As depicted, an end face of the flange 36 may be flush with the surrounding surface on the first side 10a of the first component. However, it is also envisaged that the flange 36 of the compression limiter may protrude from the first side 10a of the first component and thus sit proud of the surrounding surface. In either case, the alignment feature 32 of the second end 30b of the compression limiter may be straight or tapered as described above.

Referring now to FIG. 4, it shows a method 100 of attaching the first and second components 10, 20 with the fastener 40. The method 100 begins at 110, which includes providing the compression limiter 30 within the first component bore. The compression limiter 30 may be arranged such that the alignment feature 32 protrudes beyond the first mating surface 12 of the first component.

The method 100 proceeds to 120, which includes aligning the alignment feature of the second component bore to bring together the first and second components.

The method 100 proceeds to 130, which includes fastening the first and second components together via a fastener. The fastener 40 may at this point be inserted through the compression limiter bore 34 or the fastener 40 may be pre-installed in the first component 10. With the first and second components 10, 20 aligned, the fastener 40 may pass through the second component bore 24 and may be secured via a threaded engagement with the second component or with the nut 50.

The first component 10 may be provided with one or more of the above-mentioned compression limiters 30. Likewise, the second component 20 may be provided with one or more corresponding second bores 24. However, for improved alignment between the first and second components 10, 20, the first component 10 may be provided with two or more of the above-described compression limiters 30 and the second component 20 may comprise two or more of the corresponding second bores 24.

In this way, an alignment and assembly of two components being coupled on an assembly line may be faster. By tapering a compression limiter of a first component and a receiving bore of a second component, an assembly worker may more easily insert the compression limiter into the receiving bore via a mismatch of diameters of the compression limiter and the receiving bore at respective extreme ends. The technical effect of tapering the compression limiter and the receiving bore is to decrease manufacturing costs while decreasing a packaging weight of the assembly, while still providing a desired amount of durability to the coupling of the components.

In another representation, an assembly comprises a first component attachable to a second component with a fastener, the first component having a bore, the second component comprising a bore for receiving the fastener, and a compression limiter configured to fit inside and extend through the bore of the first component, the compression limiter having a bore for receiving the fastener, wherein on a first side of the first component, the compression limiter presents a compression surface to the fastener and receives a compressive force via said compression surface, and wherein on a second side of the first component opposite the first side of the first component, the first component has a first mating surface that is configured to face a second mating surface of the second component, wherein the compression limiter extends between the first and second sides of the first component and beyond the first mating surface so as to form an alignment feature that protrudes from the first mating surface and aligns the first component with the second component during attachment of the first and second components, wherein the second component bore has a first bore portion at the second mating surface of the second component bore and a second bore portion away from the second mating surface of the second component bore, the first bore portion having a diameter that is greater than the diameter of the second bore portion, and wherein the first bore portion has a variable diameter that varies with depth of the second bore portion.

A first example of the assembly further comprises where compression limiter comprises a flange at the first side of the first component, an end face of the flange forming the compression surface.

A second example of the assembly, optionally including the first example, further includes where the compression limiter is flush with the first side of the first component.

The assembly of any of the preceding examples, further comprises where the first component bore and compression limiter bore are aligned with each other.

The assembly of any of the preceding examples, further comprises where the compression limiter is fabricated from a material with a higher yield strength than the material from which the first component is fabricated.

The assembly of any of the preceding examples, further comprises where the alignment feature of the compression limiter has a substantially constant diameter along its length.

The assembly of any of the preceding examples, further comprises where the alignment feature of the compression limiter has a diameter that tapers along its length.

The assembly of any of the preceding examples, further comprises where the shape of the alignment feature of the compression limiter corresponds to the shape of the first bore portion.

The assembly of any of the preceding examples, further comprises where the fastener is elongate and comprises a threaded section.

A method of attaching a first component and a second component together with a fastener, the first component having a first mating surface that is configured to face a second mating surface of the second component, wherein the method comprises providing a compression limiter inside and extending through a bore of the first component, wherein the compression limiter presents a compression surface to the fastener on a first side of the first component, and the first mating surface is on a second side of the first component opposite the first side of the first component, wherein the compression limiter extends between first and second sides of the first component and beyond the first mating surface so as to form an alignment feature that protrudes from the first mating surface, wherein the second component comprises a bore for receiving the fastener and the second component bore has a first bore portion at the second mating surface of the second component bore and a second bore portion away from the second mating surface of the second component bore, the first bore portion having a diameter that is greater than the diameter of the second bore portion, and wherein the first bore portion has a variable diameter that varies with depth of the second bore portion, aligning the first component with the second component during attachment of the first and second components, and fastening the first and second components together with a fastener inserted through a bore of the compression limiter.

An embodiment of a system comprises a first component comprising a first component bore with a first diameter and a second component comprising a second component bore, the first component bore traversing an entire length of the first component and the second component bore traversing an entire length of the second component, the second component bore comprising a first taper at its entry, and a compression limiter comprising a total diameter complementary to the first diameter, the compression limiter extending through an entire length of the first component bore, further comprising an alignment feature protruding outside of the first component bore, the alignment feature comprising a second taper shaped to match the first taper.

A first example of the system, further comprises where surfaces of the first taper are pressed against surfaces of the second taper when the alignment feature is inserted into the second component bore.

A second example of the system, optionally including the first example, further comprises where only the alignment feature of the compression limiter extends outside of the first component bore.

A third example of the system, optionally including the first and/or second examples, further comprises where only the alignment feature of the compression limiter enters the first component bore.

A fourth example of the system, optionally including one or more of the first through third examples, further comprises where the compression limiter comprises a second diameter equal to a difference between a thickness of the compression limiter and the first diameter.

A fifth example of the system, optionally including one or more of the first through fourth examples, further comprises where the first component and the second component comprise a plastic material.

A sixth example of the system, optionally including one or more of the first through fifth examples, further comprises where the compression limiter comprises a ceramic, metal, a composite material, or a combination thereof.

A seventh example of the system, optionally including one or more of the first through sixth examples, further comprises where the second component bore comprises a first bore portion and a second bore portion, the first bore portion comprising the first taper shaped to receive the alignment feature, and where the first bore portion is separated from the second bore portion via a third taper.

An eighth example of the system, optionally including one or more of the first through seventh examples, further comprises where the third taper comprises an angle greater than an angle of the first and second tapers.

A ninth example of the system, optionally including one or more of the first through eighth examples, further comprises where the angle of the first and second tapers is less than 15 degrees and where the angle of the third taper is greater than 30 degrees.

A tenth example of the system, optionally including one or more of the first through ninth examples, further comprises where an extreme end of the compression limiter contacts the third taper, wherein the third taper is shaped to block further penetration of the compression limiter into the second component bore.

An eleventh example of the system, optionally including one or more of the first through tenth examples, further comprises where the first component comprises a first mating surface shaped to be pressed against a second mating surface of the second component with no intervening components arranged therebetween when the first component is physically coupled to the second component via a fastener extending through the first component bore and the second component bore.

A twelfth example of the system, optionally including one or more of the first through eleventh examples, further comprises where the first component comprises a first mating surface and the second component comprises a second mating surface, and where a gasket is arranged between the first mating surface and the second mating surface when the first component is physically coupled to the second component via a fastener extending through the first component bore and the second component bore.

An embodiment of an assembly comprises a first component comprising a first mating surface, the first component further comprising a first component bore comprising a first diameter throughout a length of the first component bore, a compression limiter traversing an entire length of the first component bore, the compression limiter comprising a compression limiter bore comprising a second diameter through an entire length of the compression limiter bore, and where exterior surfaces of the compression limiter are pressed against interior surfaces of the first component, the compression limiter further comprising an alignment feature extending outside of the first component bore past the first mating surface, the alignment feature comprising an alignment feature taper extending from the exterior surface toward the compression limiter bore, and a second component comprising a second mating surface, the second component further comprising a second component bore comprising a first bore portion and a second bore portion, the first bore portion comprising a first bore portion taper shaped to receive the alignment feature taper.

A first example of the assembly further includes where the first bore portion taper and the alignment feature taper decrease in diameter from an initial diameter closer in length to the first diameter to a final diameter between the first diameter and the second diameter.

A second example of the assembly, optionally including the first example, further includes where a difference between the final diameter and the first diameter is less than a difference between the final diameter and the second diameter.

A third example of the assembly, optionally including the first and/or second examples, further includes where the first bore portion is separated from the second bore portion via a stopping taper, and where the stopping taper blocks the compression limiter from penetrating the second component bore past an extreme end of the first bore portion.

A fourth example of the assembly, optionally including one or more of the first through third examples, further includes where a diameter of the second bore portion is equal to the second diameter.

A fifth example of the assembly, optionally including one or more of the first through third examples, further includes where the alignment feature taper and the first bore portion taper comprise a taper angle, and where the taper angle is between 5 to 15 degrees.

A sixth example of the assembly, optionally including one or more of the first through fifth examples, further includes where the alignment feature taper is arranged completely outside of the first component bore.

An embodiment of a system comprises a first component comprising a first mating surface, the first component further comprising a first component bore comprising a first diameter throughout a length of the first component bore, a compression limiter traversing an entire length of the first component bore, the compression limiter comprising a compression limiter bore comprising a second diameter through an entire length of the compression limiter bore, and where exterior surfaces of the compression limiter are pressed against interior surfaces of the first component, the compression limiter further comprising an alignment feature extending outside of the first component bore past the first mating surface, the alignment feature comprising an alignment feature taper extending from the exterior surface toward the compression limiter bore, and a second component comprising a second mating surface, the second component further comprising a second component bore comprising a first bore portion and a second bore portion, the first bore portion comprising a first bore portion taper shaped to receive the alignment feature taper, wherein the first bore portion taper and the alignment feature taper decrease in diameter from an initial diameter closer in length to the first diameter to a final diameter between the first diameter and the second diameter, and where a difference between the final diameter and the first diameter is less than a difference between the final diameter and the second diameter.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A system comprising:
a first component comprising a first component bore with a first diameter and a second component comprising a second component bore, the first component bore traversing an entire length of the first component and the second component bore traversing an entire length of the second component, the second component bore comprising a first taper at its entry; and
a compression limiter comprising a total diameter complementary to the first diameter, the compression limiter extending through an entire length of the first component bore, further comprising an alignment feature protruding outside of the first component bore, the alignment feature comprising a second taper shaped to match the first taper.

2. The system of claim 1, wherein surfaces of the first taper are pressed against surfaces of the second taper when the alignment feature is inserted into the second component bore.

3. The system of claim 1, wherein only the alignment feature of the compression limiter extends outside of the first component bore.

4. The system of claim 1, wherein only the alignment feature of the compression limiter enters the first component bore.

5. The system of claim 1, wherein the compression limiter comprises a second diameter equal to a difference between a thickness of the compression limiter and the first diameter.

6. The system of claim 1, wherein the first component and the second component comprise a plastic material.

7. The system of claim 1, wherein the compression limiter comprises a ceramic, a metal, a composite material, or a combination thereof.

8. The system of claim 1, wherein the second component bore comprises a first bore portion and a second bore portion, the first bore portion comprising the first taper shaped to receive the alignment feature, and where the first bore portion is separated from the second bore portion via a third taper.

9. The system of claim 8, wherein the third taper comprises an angle greater than an angle of the first and second tapers.

10. The system of claim 8, wherein the angle of the first and second tapers is less than 15 degrees and where the angle of the third taper is greater than 30 degrees.

11. The system of claim 8, wherein an extreme end of the compression limiter contacts the third taper, wherein the third taper is shaped to block further penetration of the compression limiter into the second component bore.

12. The system of claim 1, wherein the first component comprises a first mating surface shaped to be pressed against a second mating surface of the second component with no intervening components arranged therebetween when the first component is physically coupled to the second component via a fastener extending through the first component bore and the second component bore.

13. The system of claim 1, wherein the first component comprises a first mating surface and the second component comprises a second mating surface, and where a gasket is arranged between the first mating surface and the second mating surface when the first component is physically coupled to the second component via a fastener extending through the first component bore and the second component bore.

14. An assembly comprising:
a first component comprising a first mating surface, the first component further comprising a first component bore comprising a first diameter throughout a length of the first component bore;
a compression limiter traversing an entire length of the first component bore, the compression limiter comprising a compression limiter bore comprising a second diameter through an entire length of the compression limiter bore, and where exterior surfaces of the compression limiter are pressed against interior surfaces of the first component, the compression limiter further comprising an alignment feature extending outside of the first component bore past the first mating surface, the alignment feature comprising an alignment feature taper extending from the exterior surface toward the compression limiter bore; and
a second component comprising a second mating surface, the second component further comprising a second component bore comprising a first bore portion and a second bore portion, the first bore portion comprising a first bore portion taper shaped to receive the alignment feature taper.

15. The assembly of claim 14, wherein the first bore portion taper and the alignment feature taper decrease in diameter from an initial diameter closer in length to the first diameter to a final diameter between the first diameter and the second diameter.

16. The assembly of claim 14, wherein a difference between the final diameter and the first diameter is less than a difference between the final diameter and the second diameter.

17. The assembly of claim 14, wherein the first bore portion is separated from the second bore portion via a stopping taper, and where the stopping taper blocks the compression limiter from penetrating the second component bore past an extreme end of the first bore portion.

18. The assembly of claim 14, wherein a diameter of the second bore portion is equal to the second diameter.

19. The assembly of claim 14, wherein the alignment feature taper and the first bore portion taper comprise a taper angle, and where the taper angle is between 5 to 15 degrees, wherein the alignment feature taper is arranged completely outside of the first component bore.

20. A system comprising:
a first component comprising a first mating surface, the first component further comprising a first component bore comprising a first diameter throughout a length of the first component bore;
a compression limiter traversing an entire length of the first component bore, the compression limiter comprising a compression limiter bore comprising a second diameter through an entire length of the compression limiter bore, and where exterior surfaces of the compression limiter are pressed against interior surfaces of the first component, the compression limiter further comprising an alignment feature extending outside of the first component bore past the first mating surface, the alignment feature comprising an alignment feature taper extending from the exterior surface toward the compression limiter bore; and
a second component comprising a second mating surface, the second component further comprising a second component bore comprising a first bore portion and a second bore portion, the first bore portion comprising a first bore portion taper shaped to receive the alignment feature taper, wherein the first bore portion taper and the alignment feature taper decrease in diameter from an initial diameter closer in length to the first diameter to a final diameter between the first diameter and the second diameter, and where a difference between the final diameter and the first diameter is less than a difference between the final diameter and the second diameter.
